(19) United States
(12) Patent Application Publication
(10) Pub. No.: US 2026/0121209 A1
(43) Pub. Date: Apr. 30, 2026

(54) POWER STORAGE DEVICE

(71) Applicant: Prime Planet Energy & Solutions, Inc., Tokyo (JP)

(72) Inventor: Yoshihiko SATO, Asago-shi (JP)

(21) Appl. No.: 19/321,297

(22) Filed: Sep. 8, 2025

(30) Foreign Application Priority Data
Oct. 25, 2024 (JP) 2024-188353

(51) Int. Cl. H01M 50/325; H01M 50/119; H01M 50/342

(52) U.S. Cl. CPC H01M 50/325; H01M 50/119; H01M 50/3425; H01M 2220/20

(57) ABSTRACT

A power storage device includes a case made of metal, and an electrode body housed in the case. The case has a composite valve including a non-return type safety valve section having a first valve opening pressure, and a backflow prevention mechanism that is arranged in series with the safety valve section and has a second valve opening pressure that is lower than the first valve opening pressure. The backflow prevention mechanism is configured to close when a case inside pressure decreases after release of gas in the case due to opening of the safety valve section and the backflow prevention mechanism, to prevent outside air from flowing into the case from outside the case.

### CROSS-REFERENCE TO RELATED APPLICATIONS

This application is based upon and claims the benefit of priority from the prior Japanese Patent Application No. 2024-188353 filed on Oct. 25, 2024, the entire contents of which are incorporated herein by reference.

### BACKGROUND

### Technical Field

The disclosure relates to a power storage device equipped with a safety valve.

### Related Art

A secondary battery using a return type safety valve is known, as in Japanese unexamined patent application publication No. 2007-59145 (JP 2007-59145 A). On the other hand, a secondary battery using a non-return type safety valve is also known, as in Japanese unexamined patent application publication No. 2023-88663 (JP 2023-88663 A).

### SUMMARY

### Technical Problems

The secondary battery using the return type safety valve can discharge the internal gas each time the internal pressure of a case increases, preventing the internal pressure from becoming abnormally high. However, it is difficult for the return-type safety valve to maintain complete airtightness between a valve and a valve seat, for example, over a long period of time. It may also be difficult to maintain the same valve opening pressure over a long period of time, due to sticking or fouling between the valve and the valve seat.

On the other hand, the secondary battery using the non-return type safety valve can maintain high airtightness while the safety valve is not open. In addition, it is easy to keep the valve opening pressure of the safety valve constant. However, the non-return type safety valve cannot be closed once it is opened. Therefore, after the safety valve is opened, the outside air flows back into the case through the safety valve in the open state, or the inside and outside of the case communicates with each other and the inside of the battery remains exposed to the outside air, which is undesirable.

The disclosure was made in view of the above situation, and provides a power storage device that can maintain a high degree of airtightness and appropriately prevent the outside air from flowing back into a case or prevent the inside and outside of the case from communicating with each other after a valve is opened.

### Means of Solving the Problems

(1) One aspect of the disclosure for solving the above problem is a power storage device including a case made of metal, and an electrode body housed in the case, wherein the case has a composite valve including a safety valve section of a non-return type having a first valve opening pressure, and a backflow prevention mechanism that is arranged in series with the safety valve section and has a second valve opening pressure that is lower than the first valve opening pressure. The backflow prevention mechanism is configured to close when a case inside pressure decreases after release of gas in the case due to opening of the safety valve section and the backflow prevention mechanism, to prevent outside air from flowing into the case from outside the case.

The power storage device has the composite valve including the non-return type safety valve section and the backflow prevention mechanism arranged in series with the safety valve section. When the case inside pressure increases for some reason, both the non-return-type safety valve section and the backflow prevention mechanism are opened. As a result, the gas in the case is released to the outside through the opened safety valve section and backflow prevention mechanism, so that the inside pressure can be safely reduced. Furthermore, when the differential pressure between the inside pressure of the case and the atmospheric pressure falls below the second valve opening pressure after release of the gas, the backflow prevention mechanism closes though the non-return type safety valve section remains open. Thus, the outside air can be prevented from flowing from the outside of the case into the case. It is also possible to prevent the inside and outside of the case from remaining communicating with each other.

Examples of the power storage device include secondary batteries, such as a nickel-metal hydride secondary battery (Ni-MH), a lithium-ion secondary battery, and a sodium-ion secondary battery, and capacitors, such as a lithium-ion capacitor. The metal that forms the case may be selected taking account of the electrolyte, etc. used in the power storage device. Examples of the metal include aluminum and stainless steel.

The composite valve includes the non-return type safety valve section and the backflow prevention mechanism arranged in series with the safety valve section. The series arrangement of the safety valve section and the backflow prevention mechanism refers to the positional relationship of the safety valve section and the backflow prevention mechanism in which a gas discharge path is set such that the gas in the case passes through one of the opened safety valve section and backflow prevention mechanism, and then through the other of the safety valve section and the backflow prevention mechanism, to be released to the outside. Here, the non-return type safety valve section means a safety valve section of a type that opens when the differential pressure between the inside and the outside reaches the first valve opening pressure, remains in the open state after the valve opens, and does not return to the original closed state even if the differential pressure decreases. The backflow prevention mechanism means a mechanism configured to open when the differential pressure between the inside and the outside reaches the second valve opening pressure and return to the original closed state when the differential pressure decreases to be lower than the second valve opening pressure, thus preventing backflow from the outside to the inside. Examples of the backflow prevention mechanism include a check valve, namely, a backflow prevention valve.
(2) Furthermore, the power storage device described in (1) above may include a combustible nonaqueous electrolyte that is contained in the case and permeates the electrode body.
(3) In the power storage device described in (1) above, the electrode body may have an electrode plate having an active material layer including carbon-based active material particles.
(4) Furthermore, in the power storage device described in (1) above, the safety valve section may be provided in a case side wall that constitutes the case, and the backflow prevention mechanism may be hermetically attached from outside to a valve surrounding portion of the case side wall that surrounds the safety valve section, to hermetically cover the safety valve section from outside the case.
(5) In the power storage device described in (1) above, the safety valve section may be provided in a case side wall that constitutes the case, and the backflow prevention mechanism may be hermetically attached from inside to a valve surrounding portion of the case side wall that surrounds the safety valve section, to hermetically cover the safety valve section from inside the case.
(6) In the power storage device described in (1) above, the backflow prevention mechanism may have a main body portion formed integrally with a case side wall that constitutes the case, and the safety valve section may be provided integrally with the backflow prevention mechanism.
(7) In the power storage device described in (1) above, the composite valve may have an independent composite valve structure, and the composite valve structure may be attached to a case side wall that constitutes the case.

### BRIEF DESCRIPTION OF THE DRAWINGS

FIG. 1 is a partially enlarged cross-sectional view showing a safety valve and a backflow prevention mechanism that make up a composite valve, and its vicinity, in a battery according to a first embodiment;

FIG. 2 is an explanatory view according to the first embodiment, showing release of gas through the safety valve and the backflow prevention mechanism;

FIG. 3 is an explanatory view according to the first embodiment, showing a state in which the backflow prevention mechanism is closed after gas release;

FIG. 4 is a partially enlarged cross-sectional view showing a safety valve and a backflow prevention mechanism that make up a composite valve, and its vicinity, in a battery according to a second embodiment;

FIG. 5 is an explanatory view according to the second embodiment, showing release of gas through the safety valve and the backflow prevention mechanism;

FIG. 6 is an explanatory view according to the second embodiment, showing a state in which the backflow prevention mechanism is closed after gas release;

FIG. 7 is a partially enlarged cross-sectional view showing a safety valve and a backflow prevention mechanism that make up a composite valve, and its vicinity, in a battery according to a third embodiment;

FIG. 8 is a partially enlarged cross-sectional view showing a safety valve and a backflow prevention mechanism that make up a composite valve, and its vicinity, in a battery according to a fourth embodiment;

FIG. 9 is a partially enlarged cross-sectional view showing a safety valve and a backflow prevention mechanism that make up a compositive valve structure, and its vicinity, in a battery according to a fifth embodiment; and

FIG. 10 is a partially enlarged cross-sectional view showing a safety valve and a backflow prevention mechanism that make up a composite valve structure, and its vicinity, in a battery according to a first modified example.

### DETAILED DESCRIPTION OF THE EXEMPLARY EMBODIMENTS

### First Embodiment

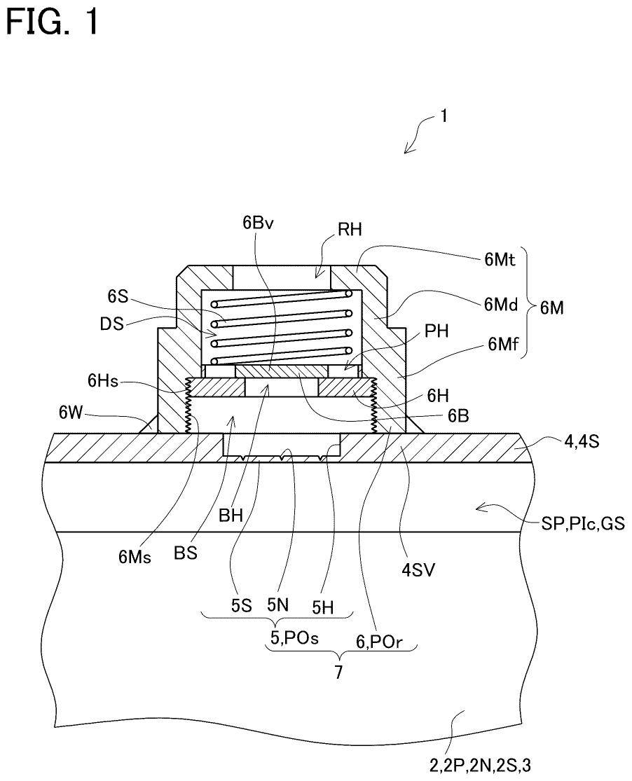

A battery 1 (one example of the power storage device of the disclosure), which is a lithium-ion secondary battery, according to one embodiment of the disclosure will be described with reference to FIG. 1 to FIG. 3. The battery 1 is a rectangular, sealed lithium-ion secondary battery, and is installed in vehicles, such as hybrid electric vehicles, plug-in hybrid electric vehicles, and battery electric vehicles, and in various types of equipment.

The battery 1 of this embodiment consists of a case 4, an electrode body 2 housed inside the case 4, positive and negative terminals (not shown) fixed to the case 4, and electrolyte 3 contained in the case 4. The case 4 is made of metal (aluminum in this embodiment) and is in the form of a rectangular parallelepiped box. In the case 4, the electrode body 2 is covered with a bag-shaped insulating film (not shown). The electrolyte 3 contained in the case 4 partly permeates the electrode body 2, while the other part of the electrolyte 3 collects on a bottom (not shown) of the case 4.

The electrode body 2 housed in the case 4 consists of positive electrode plates 2P in the form of rectangular plates and negative electrode plates 2N in the form of rectangular plates stacked in a direction perpendicular to the plane of paper in FIG. 1 via separators 2S in the form of rectangular plates. Of the electrode body 2, the positive electrode plate 2P has positive electrode active material layers 2PA comprising positive electrode active material particles, conductive particles, and a binder, on both surfaces thereof. In this embodiment, lithium transition metal composite oxide particles, specifically, lithium nickel cobalt manganese composite oxide particles, for example, are used as the positive electrode active material particles. Acetylene black (AB), for example, is used as the conductive particles. Polyvinylidene fluoride (PVDF), for example, is used as the binder. On the other hand, the negative electrode plate 2N has negative electrode active material layers 2NA comprising negative electrode active material particles and a binder, on both surfaces thereof. In this embodiment, graphite particles 2NAC are used as the negative electrode active material particles. The graphite particles 2NAC are one example of carbon-based active material particles. Examples of the carbon-based active material particles include carbon-based active materials, such as acetylene black, and carbon nanotubes, in addition to the above-mentioned graphite particles.

The electrolyte 3 is a combustible nonaqueous electrolyte having an organic solvent and a fluorine-containing lithium salt as a supporting electrolyte salt. In this embodiment, a mixture of ethylene carbonate, ethyl methyl carbonate, and dimethyl carbonate is used as the organic solvent. LiPF₆ is used as the fluorine-containing lithium salt. An example of the nonaqueous electrolyte is a nonaqueous solution electrolyte in which the electrolyte salt is dissolved in the combustible organic solvent as described above. Examples of the combustible organic solvent used in the nonaqueous electrolyte include cyclic carbonate esters, such as propylene carbonate and ethylene carbonate, and chain carbonates, such as dimethyl carbonate, diethyl carbonate, and ethyl methyl carbonate.

Furthermore, the battery 1 has a composite valve 7 at one of six case side walls that make up the rectangular parallelepiped case 4. Specifically, a lid 4S of the case 4, which closes the opening of a rectangular tube-like case body with a bottom that is not illustrated, has the composite valve 7 that consists of a non-return type safety valve section 5 and a check valve section 6 as one example of the backflow prevention mechanism. A case inside space SP exists between the lid 4S and the electrode body 2 housed therein. The pressure of gas GS present in the case inside space SP will be referred to as case inside pressure PIc.

The safety valve section 5 of the composite valve 7 of the first embodiment is provided in the lid 4S. More specifically, the lid 4S is obtained by press molding, and the safety valve section 5 is formed integrally with the lid 4S. Meanwhile, unlike the safety valve section 5, the check valve section 6 is a return-type valve section that can be repeatedly opened and closed. The check valve section 6 is hermetically attached from the outside (the upper side in FIG. 1) to a valve surrounding portion 4SV of the lid 4S that surrounds the safety valve section 5, to hermetically cover the safety valve section 5 from the outside of the lid 4S. In the first embodiment, a leg portion 6Mf of the check valve section 6 that will be described below is hermetically welded to the valve surrounding portion 4SV of the lid 4S over the entire circumference with a weld 6W by laser welding. In this manner, the check valve section 6 is arranged in series with the safety valve section 5. That is, as described below, a gas discharge path is set so that the gas GS in the case 4 is released to the outside through the safety valve section 5 that is opened, and then through the check valve section 6.

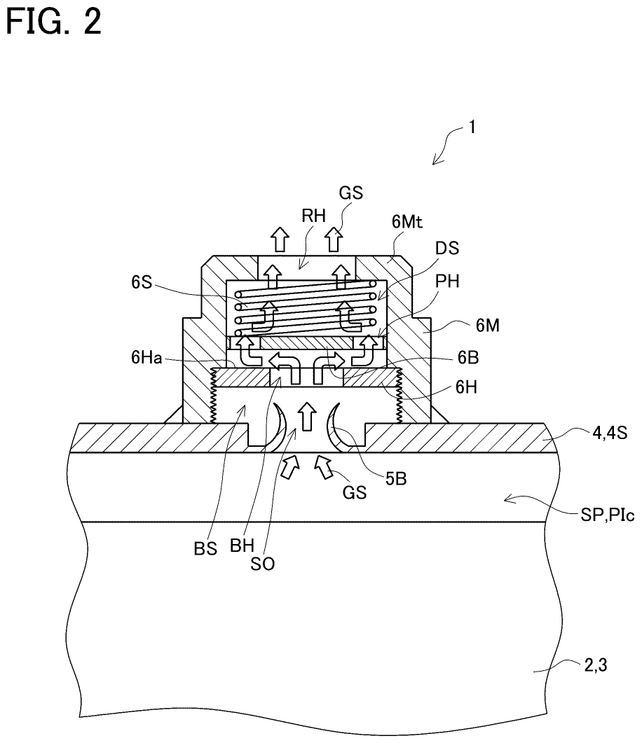

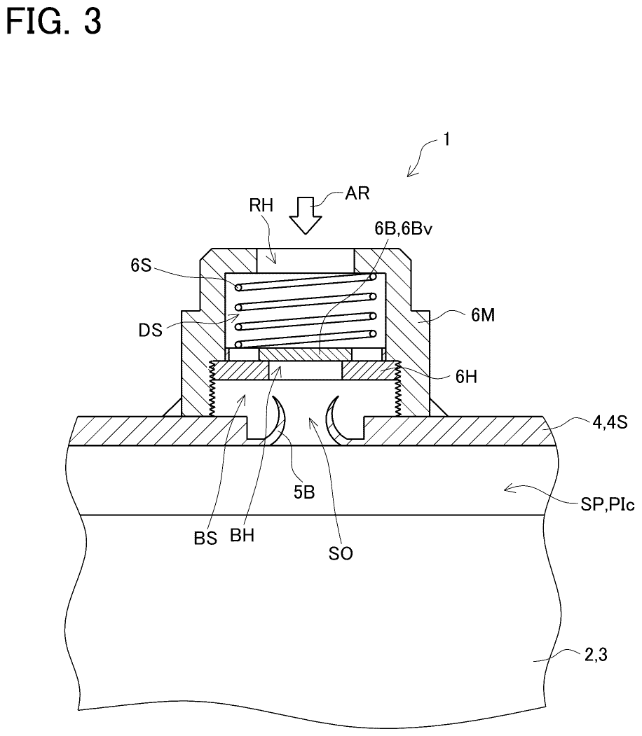

The safety valve section 5 of the first embodiment consists of a circular valve recess 5H that is recessed inward (downward in FIG. 1) and a valve body 5S in the form of a thin plate provided in the valve recess 5H. In the valve body 5S, a notch 5N in the form of a V-groove in cross section is formed in a predetermined shape or pattern (e.g., a pattern of a circle and letter X overlapping). The first valve opening pressure of the valve body 5S will be referred to as “burst pressure POs”. Specifically, when a differential pressure between the case inside pressure PIc and the atmospheric pressure exceeds the burst pressure POs as the first valve opening pressure, the valve body 5S bursts at the notch 5N and opens to become a burst portion 5B that warps outward, as shown in FIG. 2 by way of example, thereby to release the gas GS in the case inside space SP to the outside. The safety valve section 5 is a so-called non-return type or break type safety valve, and cannot be closed once it is opened. Thus, as shown in FIG. 3, even if the differential pressure between the case inside pressure PIc and the atmospheric pressure falls below the burst pressure POs after the valve opens, the burst portion 5B does not return to the original shape, and the inside and outside of the valve remain communicating with each other through the safety valve section 5.

On the other hand, the check valve section 6 includes a generally cylindrical valve body member 6M made of metal (aluminum in the first embodiment), an annular valve hole plate 6H comprising a stainless steel plate and having a valve hole BH at the center, a valve body plate 6B similarly comprising a stainless steel plate, and a coil spring 6S made of spring steel. The valve body plate 6B has a valve body portion 6Bv that faces the valve hole BH and closes it, in its central portion, and has a gas passage hole PH penetrating in the thickness direction, around the valve body portion 6Bv. The valve body member 6M consists of a cylindrical leg portion 6Mf provided with a female screw 6Ms on the inner side, a stepped, cylindrical trunk portion 6Md that extends outward (upward in FIG. 1) from the leg portion 6Mf, and a top portion 6Mt that is located outside of the trunk portion 6Md to close the trunk portion 6Md from the outside and has a top release hole RH in the form of a through-hole in its central portion. The valve hole plate 6H has a male screw 6Hs formed at its periphery. To produce the check valve section 6, the coil spring 6S and the valve body plate 6B are inserted in this order into the trunk space DS in the trunk portion 6Md of the valve body member 6M, and the valve hole plate 6H provided with the male screw 6Hs at its periphery is screwed into the valve closed space BS in the leg portion 6Mf, using the female screw 6Ms of the leg portion 6Mf, to compress the coil spring 6S in the vertical direction in FIG. 1 via the valve body plate 6B. Thus, the valve body plate 6B is biased toward the valve hole plate 6H side (the lower side in FIG. 1) under the elastic force of the coil spring 6S. With this arrangement, the valve body portion 6Bv of the valve body plate 6B is pressed against the valve hole plate 6H to close the valve hole BH.

However, in the check valve section 6, when the air pressure in the valve closed space BS of the leg portion 6Mf and the valve hole BH becomes higher than the air pressure in the trunk space DS of the trunk portion 6Md as the open space, that is, the atmospheric pressure, and the differential pressure exceeds a valve opening pressure POr as the second valve opening pressure, the valve body plate 6B moves upward, as shown in FIG. 2, and the valve hole BH closed by the valve body portion 6Bv is unclosed. As a result, the gas GS is discharged from the valve closed space BS to the outside, through the valve hole BH, a gap between the valve hole plate 6H and the valve body plate 6B, the gas passage hole PH, the trunk space DS, and the top release hole RH.

Then, when the gas GS is released and the differential pressure between the air pressure in the valve closed space BS and the valve hole BH and the outside air AR falls below the valve opening pressure POr, the valve body plate 6B moves downward and contacts the valve hole plate 6H due to the bias force of the coil spring 6S, and the valve hole BH is closed again by the valve body portion 6Bv. Thus, the check valve section 6 is the return-type valve that can be repeatedly opened and closed. Since the check valve section 6 remains closed when the air pressure in the valve closed space BS and the valve hole BH is lower than the atmospheric pressure of the outside air AR, it also functions as a check valve that prevents the outside air AR from flowing back from the top release hole RH toward the valve closed space BS. When the safety valve section 5 has not burst, that is, when the safety valve section 5 is not opened, the air pressure in the valve closed space BS and the valve hole BH is approximately equal to the atmospheric pressure at the time of manufacture of the battery 1.

Furthermore, in the battery 1 of the first embodiment, the valve opening pressure POr of the check valve section 6 is set lower than the burst pressure POs of the safety valve section 5 (POs>POr). Therefore, in the battery 1, the safety valve section 5 opens when the case inside pressure PIc increases rapidly for some reason, such as internal short-circuit or abnormal heating, and the case inside pressure PIc (the differential pressure between the case inside pressure PIc and the atmospheric pressure) exceeds the burst pressure POs. Moreover, the check valve section 6 opens subsequently (see FIG. 2). As a result, the gas GS in the case 4 is released to the outside through the burst opening SO of the safety valve section 5 that is opened and through the inside of the check valve section 6, so that the case inside pressure PIc can be safely reduced.

Furthermore, when the release of the gas GS is completed and the differential pressure between the case inside pressure PIc and the atmospheric pressure falls below the valve opening pressure POr of the check valve section 6, the check valve section 6 is closed, though the burst opening SO remains open, that is, the safety valve section 5 remains open, as shown in FIG. 3. Thus, the outside air AR can be prevented from flowing back from the outside of the case 4 to the inside. It is also possible to prevent the inside and outside of the case 4 from remaining communicating with each other. In the first embodiment, the valve closed space BS is provided in the leg portion 6Mf of the check valve section 6, to provide a gap of sufficient height between the valve body 5S and the valve hole plate 6H. This prevents the burst portion 5B that appeared upon opening of the valve from striking the valve hole plate 6H, causing the valve body 5S to be insufficiently opened.

As described above, in the battery 1, the case 4 contains the combustible electrolyte 3. Also, the electrode body 2 has the negative electrode plates 2N having the active material layers including the carbon-based active material particles, such as graphite particles. However, the above-mentioned backflow prevention mechanism can appropriately prevent backflow of the outside air AR, thus deterring the electrolyte 3 and the carbon-based active material particles in the case 4 from contacting or remaining in contact with the outside air AR flowing back.

In addition, in the battery 1, the safety valve section 5 is provided in the lid 4S, while the check valve section 6 is provided outside the lid 4S. Therefore, there is little influence on the placement of the electrode body 2 housed in the case 4, terminal members (not shown), and others. Since the check valve section 6 is not provided in the case 4, there are fewer restrictions on the materials, etc. used for the check valve section 6, which has the advantage of greater flexibility in the configuration of the check valve section 6. In the first embodiment, the safety valve section 5 is integrated with the lid 4S by forming a part of the lid 4S by press molding, or the like, as the safety valve section 5. However, a separately formed safety valve member may be hermetically fixed to the lid 4S to seal a through-hole provided in the lid 4S.

In addition, the composite valve 7 of the battery 1 uses the safety valve section 5 in which the valve body 5S in the form of a thin plate with the notch 5N is provided in the valve recess 5H. Therefore, when the safety valve section 5 is in the unopened state, the safety valve section 5 can maintain high airtightness. It is also easy to keep the burst pressure POs of the safety valve section 5 constant. The check valve section 6 is set to the valve opening pressure POr lower than the burst pressure POs of the safety valve section 5. Thus, even if the valve opening pressure POr becomes high due to sticking or fouling between the valve body portion 6Bv and the valve hole plate 6H, for example, the safety valve section 5 and the check valve section 6 can normally open as long as the valve opening pressure POr that has become high does not exceed the burst pressure POs of the safety valve section 5. Thus, the tolerance for fluctuations in the valve opening pressure POr of the check valve section 6 is also high.

### Second Embodiment

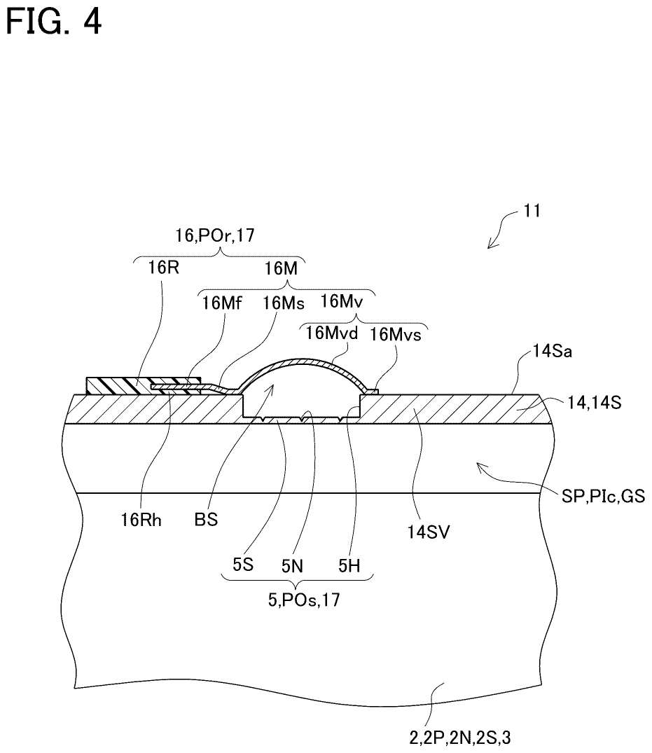

Next, a battery 11 according to a second embodiment will be described with reference to FIG. 4 to FIG. 6. The portions of the battery 11 of the second embodiment except for a composite valve 17 are substantially the same as those of the battery 1 of the first embodiment, and the description will be omitted or simplified. The composite valve 17 consists of a safety valve section 5 and a check valve section 16, of which the safety valve section 5 is substantially the same as that in the first embodiment. Thus, the check valve section 16 of the composite valve 17 will be mainly described. The check valve section 16 is arranged in series with the safety valve section 5. In the second embodiment, too, a gas discharge path is set so that gas GS in a case 14 passes through the safety valve section 5 that is opened, and then through the check valve section 16, to be released to the outside, as will be described below.

The check valve section 16 of the composite valve 17 consists of a valve body member 16M and a valve fixing member 16R that fixes a fixed portion 16Mf (which will be described below) of the valve body member 16M to a lid 14S. The valve fixing member 16R may be formed of metal or resin, but, in this embodiment, is made of thermoplastic resin, specifically, PPS, and is adhered to the outer surface 14Sa of the lid 14S by injection molding along with the valve body member 16M.

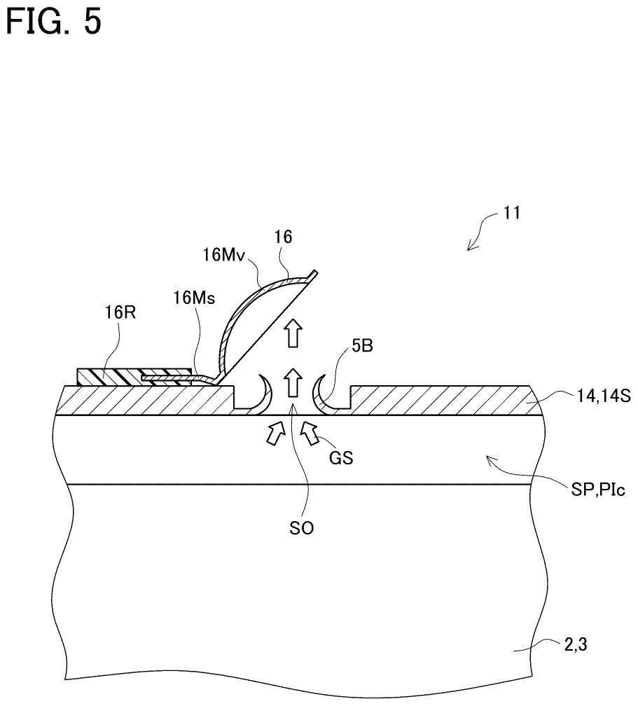

On the other hand, the valve body member 16M of the check valve section 16, which is formed by pressing a spring steel plate, consists of the fixed portion 16Mf fixed to the above-mentioned valve fixing member 16R, a plate spring portion 16Ms that extends from the fixed portions 16Mf, and a dome valve portion 16Mv that is provided in a distal end portion of the plate spring portion 16Ms and covers the safety valve section 5. Furthermore, the dome valve portion 16Mv includes a hemispherical dome portion 16Mvd that is convex outwardly (upwardly in FIG. 4), and an annular contact portion 16Mvs provided at the periphery of the hemispherical dome portion 16Mvd. The dome valve portion 16Mv is biased due to elastic deformation of the plate spring portion 16Ms so that the annular contact portion 16Mvs is hermetically pressed against and in contact with a valve surrounding portion 14SV of the lid 14S that surrounds the safety valve section 5 over the entire circumference. Therefore, when the differential pressure between the air pressure in the valve closed space BS between the safety valve section 5 and the dome valve portion 16Mv and the atmospheric pressure exceeds the valve opening pressure POr of the check valve section 16, the dome valve portion 16Mv is lifted up, and the annular contact portion 16Mvs moves apart from the valve surrounding portion 14SV, as shown in FIG. 5, so that the gas GS in the valve closed space BS is released to the outside.

Subsequently, when the gas GS is released and the differential pressure between the air pressure in the valve closed space BS and the atmospheric pressure falls below the valve opening pressure POr, the dome valve portion 16Mv moves downward under the bias force of the plate spring portion 16Ms, and the annular contact portion 16Mvs contacts the valve surrounding portion 14SV, closing the valve closed space BS again. The check valve section 16 is also a return-type valve that can be repeatedly opened and closed. The check valve section 16, which remains closed when the air pressure in the valve closed space BS is lower than the pressure of the outside air AR, also function as a check valve that prevents the outside air AR from flowing back toward the valve closed space BS from the outside.

In the second embodiment, too, the valve opening pressure POr of the check valve section 16 is set lower than the burst pressure POs of the safety valve section 5 (POr<POs). Therefore, in the battery 11, too, the safety valve section 5 opens when the case inside pressure PIc in the case 14 increases rapidly for some reason, such as internal short-circuit or abnormal heating, and the case inside pressure PIc (the differential pressure between the case inside pressure PIc and the atmospheric pressure) exceeds the burst pressure POs. Moreover, the check valve section 16 opens subsequently (see FIG. 5). As a result, the gas GS in the case 4 is released to the outside through the safety valve section 5 and check valve section 16 that are opened, so that the case inside pressure PIc can be safely reduced.

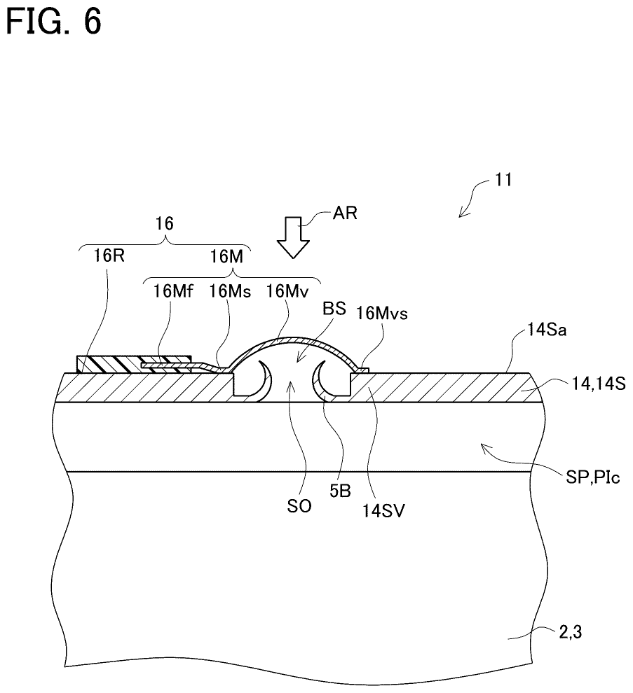

Furthermore, when the release of the gas GS is completed and the differential pressure between the case inside pressure PIc and the atmospheric pressure falls below the valve opening pressure POr of the check valve section 16, the dome valve portion 16Mv of the check valve section 16 contacts under pressure with the valve surrounding portion 14SV and the check valve section 16 is closed, though the safety valve section 5 remains open, as shown in FIG. 6. Thus, the outside air AR can be prevented from flowing back from the outside of the case 14 to the inside. It is also possible to prevent the inside and outside of the case 4 from remaining communicating with each other. In the second embodiment, too, the valve closed space BS is provided in the dome valve portion 16Mv of the check valve section 16, to provide a gap of sufficient height between the valve body 5S and the dome portion 16Mvd. This prevents the burst portion 5B that appeared upon opening of the valve from striking the dome portion 16Mvd, causing the valve body 5S to be insufficiently opened, and prevents the dome valve portion 16Mv from being unable to be closed.

In addition, the check valve section 16 is set to the valve opening pressure POr lower than the burst pressure POs of the safety valve section 5. Thus, even if the valve opening pressure POr becomes high due to sticking or fouling between the annular contact portion 16Mvs of the check valve section 16 and the valve surrounding portion 14SV of the lid 14S, for example, the safety valve section 5 and the check valve section 16 can normally open as long as the valve opening pressure POr of the check valve section 16 that has become high does not exceed the burst pressure POs of the safety valve section 5. Thus, the tolerance for fluctuations in the valve opening pressure POr of the check valve section 16 is also high.

### Third Embodiment

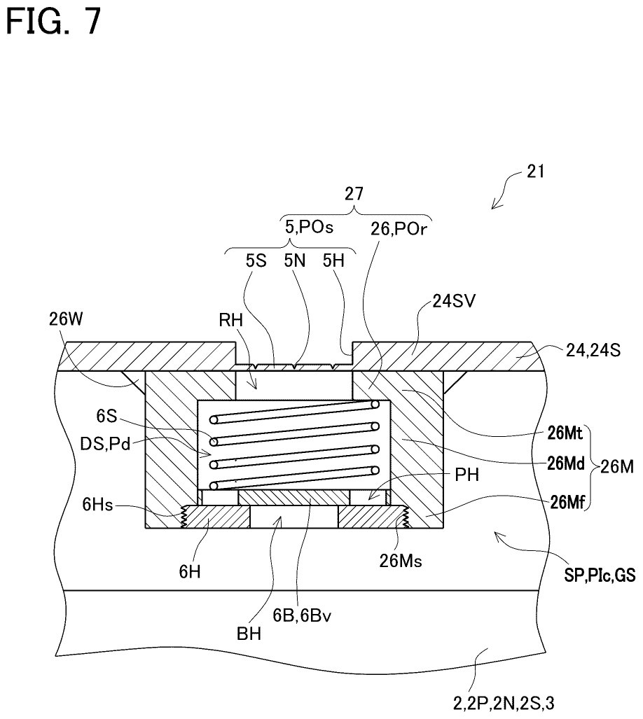

Next, a battery 21 according to a third embodiment will be described with reference to FIG. 7. The portions of the battery 21 of the third embodiment except for a composite valve 27 are substantially the same as those of the battery 1 of the first embodiment, and the description will be omitted or simplified. The composite valve 27 consists of a safety valve section 5 and a check valve section 26, and the safety valve section 5 is substantially the same as that of the first embodiment. Thus, the check valve section 26 of the composite valve 27 will be mainly described.

In the first embodiment, the check valve section 6 of the composite valve 7 is provided on the outside (the upper side in FIG. 1) of the lid 4S and the safety valve section 5. In contrast, in the composite valve 27 of the third embodiment, the check valve section 26 is provided on the inside (the lower side in FIG. 7) of a lid 24S and the safety valve section 5. Specifically, the check valve section 26 is hermetically attached from the inside to a valve surrounding portion 24SV of the lid 24S that surrounds the safety valve section 5, to hermetically cover the safety valve section 5 from the inside of the lid 24S. In the third embodiment, a top portion 26Mt of the check valve section 26 is hermetically laser-welded with a weld 26W to the valve surrounding portion 24SV of the lid 24S over the entire circumference. Thus, the check valve section 26 is arranged in series with the safety valve section 5. That is, a gas discharge path is set so that the gas GS in the case 24 is released to the outside through the check valve section 26 that is opened, and further through the safety valve section 5.

The check valve section 26 has substantially the same configuration as the check valve section 6 of the first embodiment, and thus will be described briefly. The check valve section 26 has a generally cylindrical valve body member 26M, and a valve hole plate 6H, a valve body plate 6B, and a coil spring 6S, which are similar to those of the first embodiment. The valve body member 26M consists of a leg portion 26Mf provided with a female screw 26Ms, a trunk portion 26Md, and a top portion 26Mt that closes the trunk portion 26Md from the outer side (the upper side in FIG. 7) and has a top release hole RH. To produce the check valve section 26, the coil spring 6S and the valve body plate 6B are inserted in this order into the trunk portion 26Md, and, furthermore, the valve hole plate 6H is screwed into the leg portion 26Mf using the female screw 26Ms and the male screw 6Hs, to compress the coil spring 6S in the vertical direction via the valve body plate 6B. Thus, the valve body plate 6B is biased toward the valve hole plate 6H under the elastic force of the coil spring 6S, and the valve hole BH is closed with the valve body portion 6Bv of the valve body plate 6B. However, unlike the check valve section 6 of the first embodiment, the check valve section 26 does not have the valve closed space BS inside the leg portion 26Mf.

In the check valve section 26, when the case inside pressure PIc of the case inside space SP and the valve hole BH becomes higher than the trunk inside pressure Pd in the trunk space DS and the top release hole RH as the closed space, and the differential pressure between the case inside pressure PIc and the trunk inside pressure Pd exceeds the valve opening pressure POr, the valve body plate 6B moves upward, and the valve hole BH closed by the valve body portion 6Bv is unclosed. As a result, the gas GS in the case inside space SP reaches the top release hole RH located inside the valve body 5S, through the valve hole BH, a gap between the valve hole plate 6H and the valve body plate 6B, the gas passage hole PH, and the trunk space DS, and the trunk inside pressure Pd in the trunk space DS and the top release hole RH increases toward the case inside pressure PIc. Then, when the trunk inside pressure Pd reaches an air pressure that is lower than the case inside pressure PIc by the valve opening pressure POr, the valve body plate 6B moves downward under the bias force of the coil spring 6S and contacts the valve body plate 6B, so that the valve hole BH is closed again by the valve body portion 6Bv. Thus, the check valve section 26 of the third embodiment is also a return-type valve that can be repeatedly opened and closed. Then, while the trunk inside pressure Pd is lower than the burst pressure POs of the safety valve section 5, the safety valve section 5 is not opened, and the trunk inside pressure Pd is generally kept at a pressure lower than the case inside pressure PIc of the case inside space SP by the valve opening pressure POr.

In the battery 21 of the third embodiment, too, the valve opening pressure POr of the check valve section 26 is set lower than the burst pressure POs of the safety valve section 5 (POs>POr). Therefore, when the case inside pressure PIc increases rapidly for some reason, such as internal short-circuit or abnormal heating, the differential pressure between the case inside pressure PIc and the trunk inside pressure Pd first exceeds the valve opening pressure POr, causing the check valve section 26 to open, and the gas GS flows into the trunk space DS and the top release hole RH. As a result, the trunk inside pressure Pd increases toward the case inside pressure PIc. Here, when the trunk inside pressure Pd exceeds the burst pressure POs, the safety valve section 5 opens (bursts) following the check valve section 26. As a result, the gas GS in the case inside space SP of the case 24 is released to the outside through the check valve section 26 and safety valve section 5 that are both opened, so that the case inside pressure PIc can be safely reduced.

Furthermore, when the release of the gas GS is completed and the differential pressure between the case inside pressure PIc and the atmospheric pressure falls below the valve opening pressure POr of the check valve section 26, the check valve section 26 is closed though the safety valve section 5 remains open. Thus, the outside air AR can be prevented from flowing back from the outside of the case 24 to the inside. That is, the check valve section 26 functions as a check valve, namely, a backflow prevention valve. The check valve section 26 can also prevent the inside and outside of the case 24 from remaining communicating with each other.

In the battery 21 of the third embodiment, the safety valve section 5 is provided in the lid 24S, while the check valve section 26 is provided inside the lid 24S. Therefore, the check valve section 26 is less likely to be affected by fouling from the outside. Since the check valve section 26 is not provided outside the case 4, there is an advantage of a high degree of freedom in the placement of the battery 21.

In addition, the composite valve 27 of the battery 21 also uses the safety valve section 5 in which the valve body 5S in the form of a thin plate with the notch 5N is provided in the valve recess 5H. Therefore, the safety valve section 5, when not opened, can keep a high degree of airtightness. It is also easy to keep the burst pressure POs constant.

### Fourth Embodiment

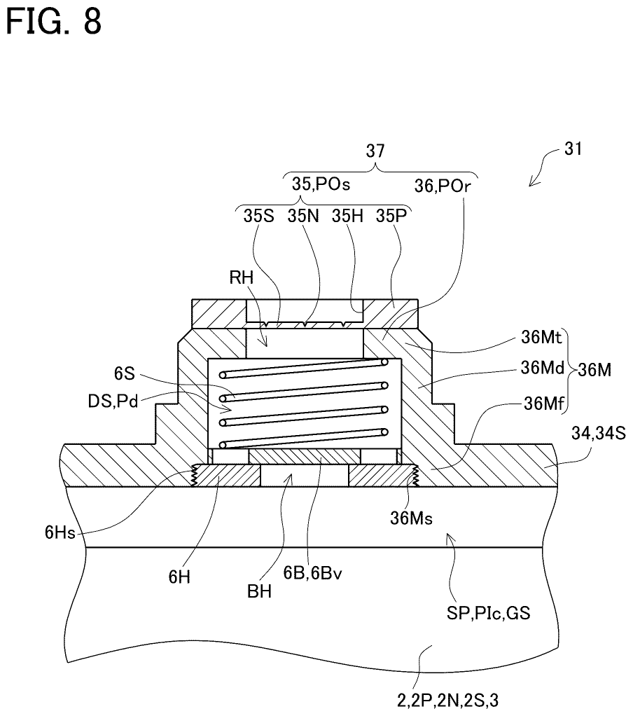

Next, a battery 31 according to a fourth embodiment will be described with reference to FIG. 8. The portions of the battery 31 of the fourth embodiment except for a composite valve 37 are substantially the same as those of the batteries 1, 21 of the first and third embodiments, and the description will be omitted or simplified. In the following, the composite valve 37 will be mainly described.

In the first and third embodiments, the non-return type safety valve section 5 of the composite valve 7, 27 is provided integrally in the lid 4S, 24S, while the check valve section 6, 26 as a separate member from the lid 4S, 24S is hermetically connected to the valve surrounding portion 4SV, 24SV of the lid 4S, 24S. In contrast, in the composite valve 37 of the fourth embodiment, a valve body portion 36M of a check valve section 36 is provided integrally in a lid 34S, and a non-return type safety valve member 35 is fixed to the valve body portion 36M.

The check valve section 36 has substantially the same structure as the check valve sections 6, 26 of the first and third embodiments, and thus will be described briefly. The check valve section 36 is provided integrally in the lid 34S by a press or other means, and includes a generally cylindrical valve body portion 36M that protrudes outwards (upward in FIG. 8) from the lid 34S, and a valve hole plate 6H, a valve body plate 6B, and a coil spring 6S similar to those of the first and third embodiments. The valve body portion 36M consists of a leg portion 36Mf with a female screw 36Ms provided inside, a cylindrical trunk portion 36Md that extends outward from the leg portion 36Mf, and a top portion 36Mt that is located outside of the trunk portion 36Md, closing the trunk portion 36Md from the outside, and has a top release hole RH as a through-hole in its central portion. In the check valve section 36, the valve body plate 6B is biased toward the valve hole plate 6H under the elastic force of the compressed coil spring 6S, so that the valve body portion 6Bv of the valve body plate 6B closes the valve hole BH. However, like the check valve section 26 of the third embodiment, the check valve section 36 does not have the valve closed space BS inside the leg portion 36Mf.

On the other hand, the non-return type safety valve member 35 as a separate member from the lid 34S is hermetically adhered to the top portion 36Mt of the valve body portion 36M provided integrally in the lid 34S. The safety valve member 35 is produced by pressing an aluminum sheet material, and a valve body 35S in the form of a thin plate with a notch 35N is provided integrally in a valve recess 35H provided in a thick valve surrounding portion 35P, as in the first and third embodiments. In the fourth embodiment, the safety valve member 35 is located such that the valve body 35S overlaps the top release hole RH of the top portion 36Mt, and the valve surrounding portion 35P is hermetically laser-welded to the top portion 36Mt over the entire circumference. The valve surrounding portion 35P of the safety valve member 35 may also be hermetically adhered to the top portion 36Mt over the entire circumference using an adhesive.

In the fourth embodiment, too, the valve opening pressure POr of the check valve section 36 is set lower than the burst pressure POs of the safety valve member 35 (POs>POr). Therefore, as in the third embodiment, in the battery 31, too, when the case inside pressure PIc increases rapidly, the check valve section 36 opens, and the gas GS flows into the trunk space DS and the top release hole RH. Furthermore, when the trunk inside pressure Pd exceeds the burst pressure POs, the safety valve member 35 opens (bursts) following the check valve section 36. The gas GS is released to the outside through the check valve section 36 and the safety valve member 35 arranged in series, so that the case inside pressure PIc can be safely reduced. When the differential pressure between the case inside pressure PIc and the atmospheric pressure subsequently becomes lower than the valve opening pressure POr, the check valve section 36 is closed, thus preventing backflow of the outside air AR into the case 34. The check valve section 36 can also prevent the inside and outside of the case 34 from remaining communicating with each other. In addition, the battery 31 of the fourth embodiment yields substantially the same effects as the battery 21 of the third embodiment.

In the battery 31, the valve body portion 36M of the check valve section 36 is formed integrally with the lid 34S. The safety valve member 35 is also provided integrally on the check valve section 36. Therefore, the power storage device having the check valve section 36 integrated with the lid 34S and the safety valve member 35 integrated with the check valve section 36 can be provided with a simple configuration.

In the fourth embodiment, an example in which the safety valve member 35 as a separate member is adhered to the top portion 36Mt has been illustrated. However, the safety valve member 35 as a separate member may be located inside and adhered to the leg portion 36Mf of the check valve section 36 or the valve hole plate 6H so that the valve body 35S overlaps the valve hole BH and closes it. Alternatively, a non-return type safety valve section may be provided integrally in a member that provides the check valve section; for example, the valve body 35S with the notch 35N may be formed integrally in the top release hole RH of the top portion 36Mt of the check valve section 36, or the valve body 35S with the notch 35N may be formed integrally in the valve hole BH of the valve hole plate 6H.

### Fifth Embodiment, First Modified Example

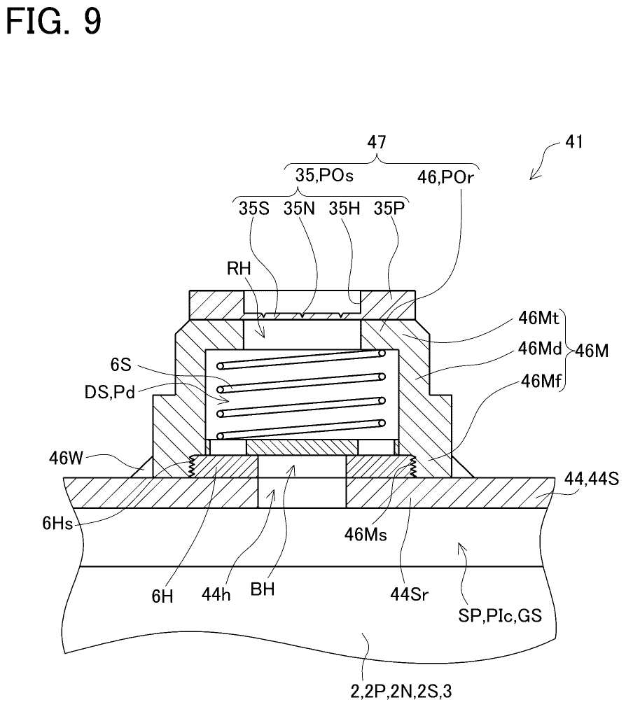

Next, a battery 41 according to a fifth embodiment will be described with reference to FIG. 9. The portions of the battery 41 of the fifth embodiment except for a composite valve structure 47 are substantially the same as those of the batteries 1, 21, 31 of the first, third, and fourth embodiments, and the description will be omitted or simplified. In the following, the composite valve structure 47 will be mainly described.

In the first, third, and fourth embodiments, a part of the composite valve 7, 27, 37, that is, the safety valve section 5 or the check valve section 36, is provided integrally with the lid 4S, 24S, 34S. In contrast, a check valve section 46 and a safety valve member 35 that make up the composite valve structure 47 of the fifth embodiment are both separate from a lid 44S, and the composite valve structure 47 is independent of the case 44, unlike the first embodiment, etc. The fifth embodiment is also different from the first embodiment, etc. in that a gas flow hole 44h is formed through the lid 44S, a leg portion 46Mf of the check valve section 46 of the composite valve structure 47 is hermetically attached from the outside to a hole surrounding portion 44Sr surrounding the gas flow hole 44h by means of a weld 46W. The check valve section 46 is arranged such that the valve hole BH of the valve hole plate 6H overlaps the gas flow hole 44h.

The safety valve member 35 of the composite valve structure 47 is substantially the same as the safety valve member 35 of the fourth embodiment, and the description is omitted. The check valve section 46 has substantially the same structure as the check valve sections 6, 26, 36 of the first, third, and fourth embodiments, and will be briefly described. The check valve section 46 includes a generally cylindrical valve body member 46M, and a valve hole plate 6H, a valve body plate 6B, and a coil spring 6S similar to those of the first embodiment, etc. The valve body member 46M consists of the leg portion 46Mf with a female screw 46Ms, a trunk portion 46Md, and a top portion 46Mt that closes the trunk portion 46Md from the outside (the upper side in FIG. 9) and has a top release hole RH. In the check valve section 46, the compressed coil spring 6S biases the valve body plate 6B toward the valve hole plate 6H, so that the valve body portion 6Bv closes the valve hole BH. The safety valve member 35 is hermetically adhered to the top portion 46Mt of the check valve section 46, as in the fourth embodiment.

In the fifth embodiment, too, the valve opening pressure POr of the check valve section 46 is set lower than the burst pressure POs of the safety valve member 35 (POs>POr). Thus, in the battery 41, too, when the case inside pressure PIc increases rapidly, the check valve section 46 opens, and the gas GS flows into the trunk space DS and the top release hole RH. Furthermore, when the trunk inside pressure Pd exceeds the burst pressure POs, the safety valve member 35 opens following the check valve section 46, to safely reduce the case inside pressure PIc. Thereafter, when the differential pressure between the case inside pressure PIc and the atmospheric pressure falls below the valve opening pressure POr, the check valve section 46 is closed to prevent backflow of the outside air AR into the case 44. The check valve section 46 can also prevent the inside and outside of the case 44 from remaining communicating with each other. In addition, the battery 41 of the fifth embodiment yields substantially the same effects as those provided by the batteries 21, 31 of the third and fourth embodiments.

In the battery 41, a composite valve including the safety valve member 35 and the check valve section 46 provides the independent composite valve structure 47. The composite valve structure 47 is attached to the lid 44S. Therefore, the composite valve structure 47 has a higher degree of freedom in form and structure, compared to the case where a valve body portion of a safety valve section or a check valve portion is formed integrally with a case side wall. By attaching the composite valve structure 47 to a case side wall, it is possible to provide a power storage device provided with the safe valve section and the backflow prevention mechanism.

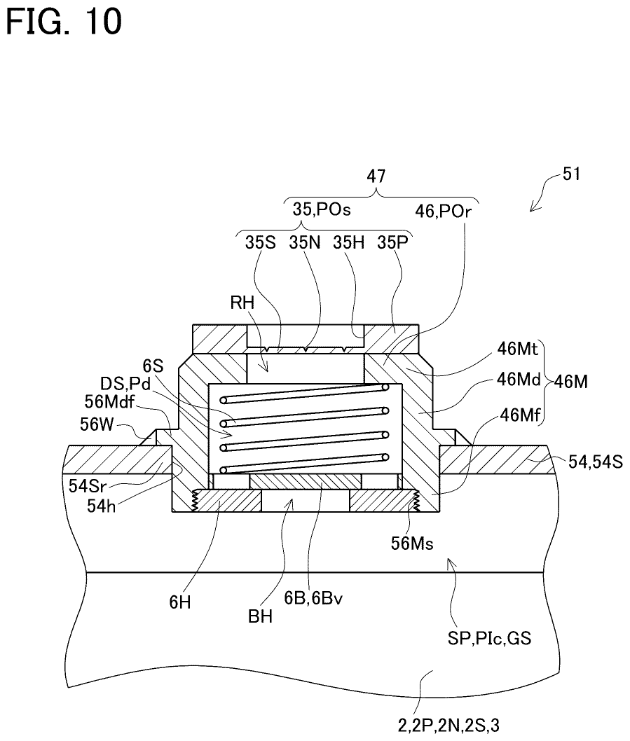

While the composite valve structure 47 may be placed outside the lid 44S, as in the fifth embodiment, it may be placed inside the lid 44S. Alternatively, the composite valve structure may be arranged to extend through the case side wall with a part of it on the outside of the case and the other part on the inside. For example, as in a battery 51 of a first modified example shown in FIG. 10, the trunk portion 46Md of the check valve section 46 is provided with an annular flange 56Mdf that protrudes in the circumferential direction. The flange 56Mdf may then be hermetically attached to a hole surrounding portion 54Sr surrounding a member insertion hole 54h formed through a lid 54S of a case 54 over the entire circumference by means of a weld 56W. In this case, both the outward and inward projection heights of the composite valve structure 47 can be reduced or limited. The check valve structure may be configured such that the safety valve member 35 is placed on the outer side of the check valve section 46, as in the fifth embodiment, or, conversely, may be configured such that the safety valve member is placed on the inner side.

While the disclosure has been described in the light of the first embodiment to the fifth embodiment and the first modified example, it is to be understood that the disclosure is not limited to the embodiments, etc., but may be applied with changes as needed, without departing from its principle. In the first embodiment, the composite valve 7 is provided at the lid 4S as one of the six case side walls that make up the rectangular parallelepiped case 4. However, a composite valve may be provided at another case side wall. In addition, composite valves may be provided at two or more locations.

### REFERENCE SIGNS LIST

1, 11, 21, 31, 41, 51 Battery (Power storage device)
2 Electrode body
3 Electrolyte (nonaqueous electrolyte)
4, 14, 24, 34, 44, 54 Case
SP Case inside space
PIc Case inside pressure
4S, 14S, 24S, 34S, 44S, 54S Lid (Case side wall)
4SV, 14SV, 24SV Valve surrounding portion
Safety valve section
Safety valve member (Safety valve section)
POs Burst pressure (First valve opening pressure)
35P Valve surrounding portion
6, 16, 26, 36, 46 Check valve section (Check mechanism)
POr Valve opening pressure (Second valve opening pressure)
6M, 16M, 26M, 46M Valve body member
36M Valve body portion (Main body)
7, 17, 27 Composite valve
37, 47 Composite valve structure (Composite valve)
GS Gas
AR Outside air

What is claimed is:

1. A power storage device comprising:
a case made of metal; and
an electrode body housed in the case,
wherein the case has a composite valve including
a safety valve section of a non-return type having a first valve opening pressure, and
a backflow prevention mechanism that is arranged in series with the safety valve section and has a second valve opening pressure that is lower than the first valve opening pressure, the backflow prevention mechanism being configured to close when a case inside pressure decreases after release of gas in the case due to opening of the safety valve section and the backflow prevention mechanism, to prevent outside air from flowing into the case from outside the case.

2. The power storage device according to claim 1, further comprising a combustible nonaqueous electrolyte that is contained in the case and permeates the electrode body.

3. The power storage device according to claim 1, wherein the electrode body has an electrode plate having an active material layer including carbon-based active material particles.

4. The power storage device according to claim 1, wherein:
the safety valve section is provided in a case side wall that constitutes the case; and
the backflow prevention mechanism is hermetically attached from outside to a valve surrounding portion of the case side wall that surrounds the safety valve section, to hermetically cover the safety valve section from outside the case.

5. The power storage device according to claim 1, wherein:
the safety valve section is provided in a case side wall that constitutes the case; and
the backflow prevention mechanism is hermetically attached from inside to a valve surrounding portion of the case side wall that surrounds the safety valve section, to hermetically cover the safety valve section from inside the case.

6. The power storage device according to claim 1, wherein:
the backflow prevention mechanism has a main body portion formed integrally with a case side wall that constitutes the case; and
the safety valve section is provided integrally with the backflow prevention mechanism.

7. The power storage device according to claim 1, wherein:
the composite valve has an independent composite valve structure; and
the composite valve structure is attached to a case side wall that constitutes the case.
